(19) United States
(12) Patent Application Publication
(10) Pub. No.: US 2008/0295346 A1
(43) Pub. Date: Dec. 4, 2008

(54) Rear axle alignment gauge and method

(76) Inventor: Robert P. Tanga, Atlanta, GA (US)

Correspondence Address: MYERS & KAPLAN;INTELLECTUAL PROPERTY LAW, L.L.C., CUMBERLAND CENTER II, 3100 CUMBERLAND BLVD , SUITE 1400, ATLANTA, GA, 30339, US

(21) Appl. No.: 11/809,814

(22) Filed: Jun. 1, 2007

(51) Int. Cl. G01B 3/22; G01B 13/18

(52) U.S. Cl. 33/337

(57) ABSTRACT

A method and apparatus for alignment of a rear axle of a motorcycle, whereby measurement is made of the relative positions of each end of the axle with respect to the axle mounting structure, thereby reducing the time necessary for aligning the axle, and increasing the accuracy of the alignment.

### BACKGROUND OF THE INVENTION

1. Technical Field

The present invention relates generally to motorcycle maintenance, and more specifically, to a method and gauge for alignment of a motorcycle rear axle.

2. Description of Related Art

In any wheeled vehicle it is important that the proper alignment of the wheels be maintained for safe and efficient operation of the vehicle. This is especially true for two wheeled vehicles, such as motorcycles, due to the danger of harm to the operator in the event of an accident. For many motorcycles, including most chain and belt driven models, the axle of the rear wheel is adjustable in order to allow adjustment of the tension on the chain or belt to a specified parameter. The rear axle may be prone, however, to misalignment due to the adjustability of the axle. When the rear axle is misaligned, excessive wear may be caused to drive-train components and the tires, and the handling characteristics of the motorcycle may be impaired, potentially increasing the likelihood of an accident.

One method of aligning the rear axle involves counting the number of threads visible on the exposed shaft of one or more of the rear axle adjustment screws or bolts. This method is problematic because it is inaccurate, tedious, and time-consuming.

These problems are exacerbated by the frequency with which the rear axle may need to be adjusted or removed for repairs or proper maintenance of the motorcycle's components. Each time the rear axle is adjusted or removed, large amounts of time may be required to adjust the position of the rear axle to ensure that there is a proper amount of tension on the chain or belt, and that the rear axle is properly aligned.

It is desirable, therefore, to provide a method of aligning the rear axle of a motorcycle that is more accurate and that can be accomplished in less time, thereby reducing or eliminating the disadvantages of known methods of aligning the rear axle during routine safety checks or after maintenance and/or repairs.

### BRIEF SUMMARY OF THE INVENTION

Briefly described, in a preferred embodiment, the present invention overcomes the above-mentioned disadvantages and meets the recognized need for such a method and device by providing a motorcycle rear axle alignment gauge comprising a housing, a probe movably engaged with the housing, and an indicator operably engaged with the probe.

According to one aspect of the preferred embodiment, the housing includes at least one portion adapted to abut a reference portion of the motorcycle.

According to another aspect of the preferred embodiment, the indicator comprises a rotating needle.

According to another aspect of the preferred embodiment, a scale is arranged around a peripheral portion of a face of the housing.

According to another aspect of the preferred embodiment, the indicator comprises an electronic display.

According to another aspect of the preferred embodiment, the gauge may be calibrated.

Accordingly, a feature and advantage of the present invention is its ability to quickly and accurately ascertain a distance between an end of a rear axle adjustment screw and a portion of a motorcycle frame.

Another feature and advantage of the present invention is its ability to quickly and accurately compare the position of a first side of an axle with a position of the second side of the axle.

Another feature and advantage of the present invention is its ability to quickly and accurately align an axle of a motorcycle.

According to another aspect, the present invention comprises a method of aligning a rear axle of a motorcycle comprising the steps of measuring a first position of a first rear axle adjustment device relative to a first portion of an axle-mounting structure of a motorcycle, and adjusting the first rear axle adjustment device to align the rear axle of the motorcycle.

These and other objects, features, and advantages of the invention will become more apparent to those ordinarily skilled in the art after reading the following Detailed Description and Claims in light of the accompanying drawing Figures.

### BRIEF DESCRIPTION OF THE DRAWINGS

Accordingly, the present invention will be understood best through consideration of, and reference to, FIGS. 1-6, viewed in conjunction with the Detailed Description of the Preferred Embodiment referring thereto, in which like reference numbers throughout the various Figures designate like structure and in which:

FIG. 1 is a front view of a preferred embodiment of the present invention;

FIG. 2 is a front partial cutaway view of the preferred embodiment of the present invention;

FIG. 3 is a side view of a rear axle of a motorcycle;

FIG. 4 is a partial cutaway view of the preferred embodiment of the present invention shown in use;

FIG. 5 is a side view of a rear axle of a motorcycle according to an alternative design; and

FIG. 6 is a front view of the preferred embodiment shown in use with the motorcycle of FIG. 5.

It is to be noted that the drawings presented are intended solely for the purpose of illustration and that they are, therefore, neither desired nor intended to limit the invention to any or all of the exact details of construction shown, except insofar as they may be deemed essential to the claimed invention.

### DETAILED DESCRIPTION OF THE INVENTION

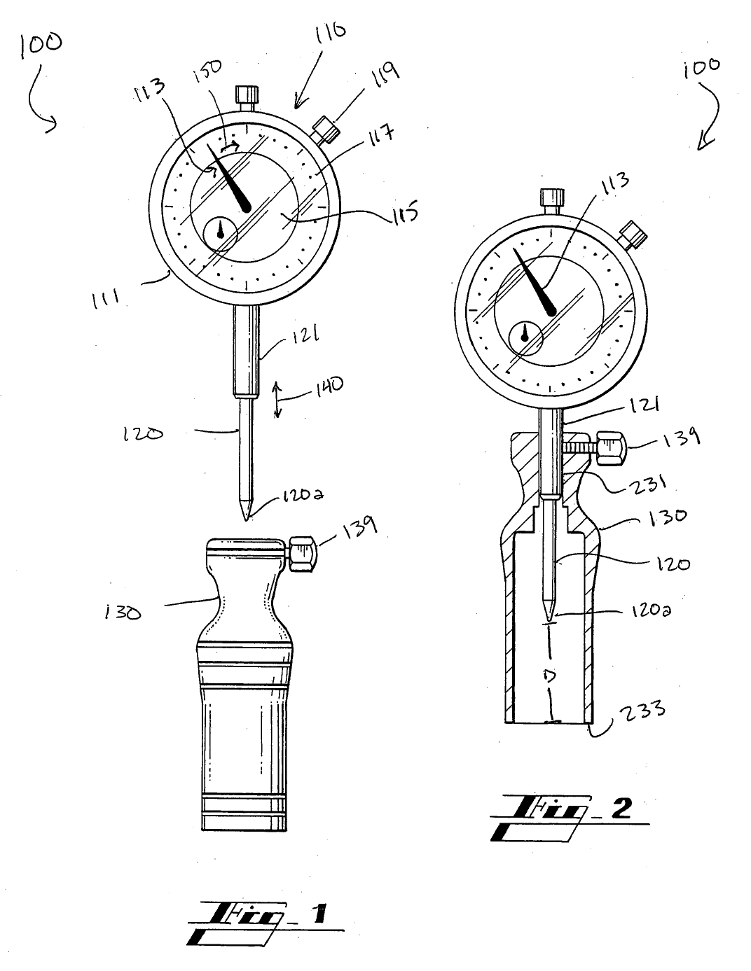

In describing preferred embodiments of the present invention illustrated in FIGS. 1-6, specific terminology is employed for the sake of clarity. The invention, however, is not intended to be limited to the specific terminology so selected, and it is to be understood that each specific element includes all technical equivalents that operate in a similar manner to accomplish a similar purpose.

In that form of the preferred embodiment of the present invention chosen for purposes of illustration, FIG. 1 shows gauge 100. Gauge 100 preferably comprises indicator 110 which is preferably operably connected to probe 120, and further comprises housing 130. More specifically, probe 120 is preferably slidably engaged with sleeve 121 such that probe 120 is free to travel, at least within a range, in a direction of the longitudinal axis of probe 120 and sleeve 121, as indicated by arrow 140. Probe 120 preferably comprises first end 120a, adapted to contact a first reference surface, and a second end, not shown, disposed within casing 111. Casing 111 may further optionally be rotatable with respect to sleeve 121. Sleeve 121 is preferably attached to casing 111 such that sleeve 121 is, at least selectively, not separable from casing 111. As such, when sleeve 121 is not separable from casing 111, the second end of probe 120 is preferably in operable engagement with indicator 110 such that movement of probe 120 in the direction of arrow 140 relative to sleeve 121 (and thus casing 111), indicator 110 moves in the direction of arrow 150 to indicate a value proportional to such movement of probe 120. The form of the operable engagement may take any of a variety of forms, such as geared, pivotal, levered, direct, rotational, or other mechanical form of engagement as will be understood by one skilled in the art. Alternatively, the engagement can be inductive, magnetic, resistive, optical, or other electronic or non-contact engagement configured and arranged to convert movement of probe 120 to a change in a value indicated by indicator 110.

A preferred one of such engagement forms includes teeth disposed along a length of the second end of probe 120 in engagement with a rotatable gear, wherein movement along the longitudinal axis of probe 120 in the direction of arrow 140 translates to rotation of the gear, and needle 113 in fixed connection with the gear, such that rotation of the gear in response to motion of probe 120 causes rotation of needle 113 in the direction of arrow 150. In such an embodiment, indicator 110 preferably includes scale 117 disposed on face 115 retained in casing 111. It should be understood, however, that indicator 110 may alternatively comprise a digital or analog electronic display, such as an LCD.

Regardless of the specific structure utilized to translate movement of probe 120 to an indication, indicator 110 preferably includes a calibration feature. In the preferred embodiment, indicator 110 preferably includes calibration portion 119 in the form of a button. Operation of calibration portion 119, such as by pushing the button, preferably disengages probe 120 from needle 113 such that a position of needle 113 relative to scale 117 may be adjusted independent of the movement of probe 120. Preferably, operation of calibration portion 119 takes the teeth of probe 120 out of engagement with the rotatable gear. Thus, for a given position of probe 120, the position of needle 113 relative to scale 117 may be adjusted to a predetermined position, such as a position associated with a zero mark of scale 117. Alternatively, however, other calibration portions may be implemented. One such alternative calibration portion comprises a rotatable face 115, whereby rotation of face 115 adjusts a position of needle 113 relative to scale 117. Another alternative calibration portion comprises threaded fastener 139 in threaded engagement with housing 130 such that loosening threaded fastener 139 allows adjustment of a position of sleeve 121, and, thus first end 120a of probe 120 for a give position relative to sleeve 120, relative to housing 130. Subsequent tightening of threaded fastener 139 preferably retains sleeve 121 in fixed engagement with housing 130.

Now referring to FIG. 2, gauge 100 is shown with sleeve 121 in fixed engagement with housing 130 due to threaded fastener 139 being in a tightened position, thereby retaining sleeve 121 in friction force fixed engagement with a sidewall of bore 231. When sleeve 120 is in such fixed engagement with housing 130, a position of needle 113 relative to scale 117 due to a position of first end 120a of probe 120 within bore 230 indicates a distance D between first end 120a of probe 120 relative to forward surface 233 of housing 130.

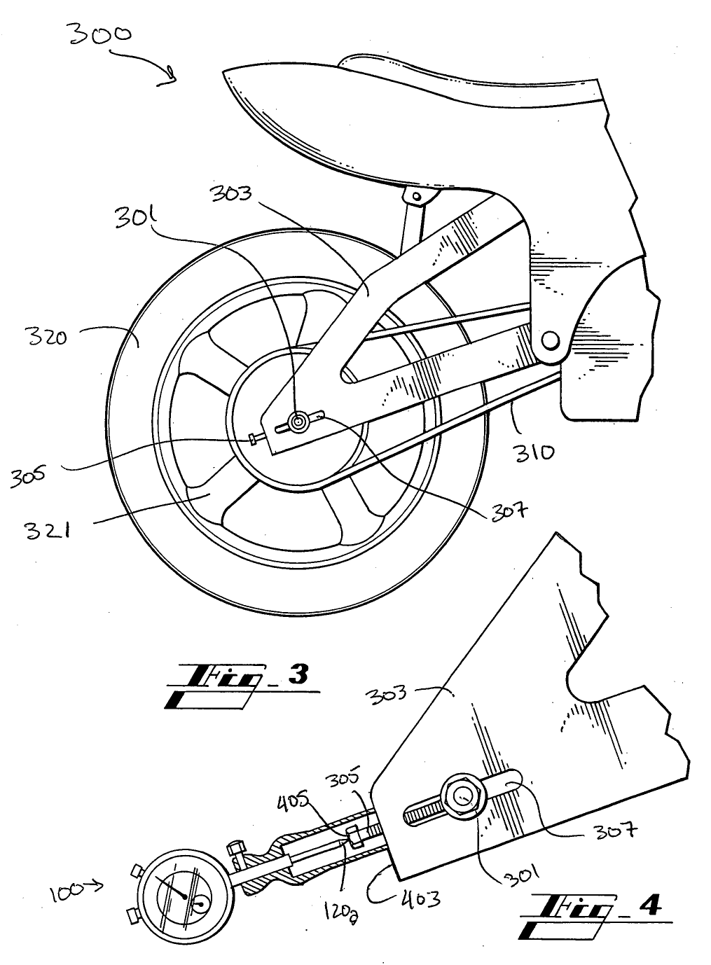

Now referring to FIG. 3, motorcycle 300 includes rear tire 320 and rear wheel 321, rotatably connected thereto by rear axle 301. For proper operation, rear axle 301 must be maintained in a proper alignment relative to rear axle mounting structure 303, in which rear axle 301 is carried. Furthermore, rear axle 301 must be maintained in a proper position within an adjustment portion, such as slot 307, of rear axle mounting structure 303 in order to maintain a proper tension of belt (or chain) 310.

In use, gauge 100 may preferably be used to determine whether rear axle 301 is in proper alignment by comparing measurements of a position of each side of a rear axle 301 within respective slots, such as slot 307. In order to make such a determination, a user may first adjust a drive-train side of axle 301 within a drive-train side adjustment slot using a drive-train side rear axle adjustment device so as to provide a proper or desired tension on a belt or chain of the drive-train. The user may then preferably measure a position of a first side of an axle within a slot by contacting forward surface 233 with a reference surface of a drive-train side rear axle mounting structure in which the drive-train side adjustment slot is disposed, thereby contacting first end 120a with a reference surface of the drive-train side rear axle adjustment device. The user may then read a first value indicated on indicator 110 representing a distance between the reference surface of the drive-train side rear axle adjustment device and the reference surface of the drive-train side rear axle mounting structure. The user may then measure a position of a second side of the axle by contacting forward surface 233 with reference surface 403 of the other rear axle mounting structure 303, thereby contacting first end 120a with reference surface 405 of the other rear axle adjustment device 305. The user may then read a second value indicated on indicator 110 representing a distance between reference surface 405 and reference surface 403 (equal to distance D of FIG. 2). If the first value and the second value are equal, then the user may determine that rear axle 301 is in proper alignment due to the respective lengths of the drive-train side rear axle adjustment device and rear axle adjustment device 305 being equal. If the first value and the second value are different, however, the user may adjust rear axle adjustment device 305, for example by tightening or loosing, in order to align rear axle 301 until a value of a measurement of the position of rear axle 301 in slot 307 is equal to the first value.

Alternatively, the user may determine whether rear axle 301 is in proper alignment by measuring a position of a first side of rear axle within a first slot by contacting forward surface 233 with a reference surface of a drive-train side rear axle mounting structure in which the drive-train side adjustment slot is disposed, thereby contacting first end 120a with a reference surface of the drive-train side rear axle adjustment device. The user may then optionally calibrate gauge 100 such that the value indicated is a predetermined value, such as zero. Such calibration may be accomplished by rotating face 115 such that needle 113 points to, or otherwise indicates, a zero value of scale 117. Alternatively, an electronic zeroing may be performed by activating a calibration portion of an electronic circuit comprising indicator 110. Once gauge 100 has been calibrated, the user may then measure a position of a second side of rear axle 301 by contacting forward surface 233 with reference surface 403 of the other rear axle mounting structure 303, thereby contacting first end 120a with reference surface 405 of the other rear axle adjustment device 305. The user may then read a second value indicated on indicator 110 representing a distance between reference surface 405 and reference surface 403. If the second value is equal to zero, then the user may determine that the axle is properly aligned, and if the second value is not zero, the user may adjust rear axle adjustment device 305 until a value of zero is indicated when forward surface 233 is contacted with reference surface 403 and when first end 120a is contacted with reference surface 405.

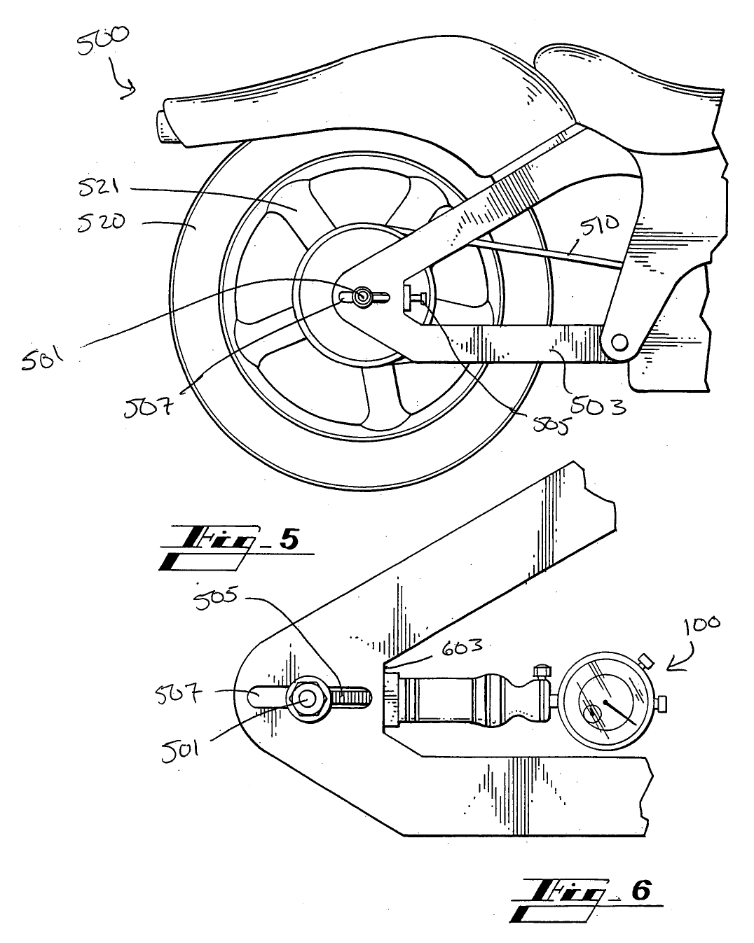

Now referring to FIGS. 5 and 6, motorcycle 500 according to an alternative design is shown. Motorcycle 500 preferably includes rear axle 501, rear axle mounting structure 503, rear axle adjustment device 505, slot 507, tire 520, wheel 521, and chain 510. According to the alternative design, rear axle adjustment device 505 is arranged on a forward side of rear axle 501, thus, reference surface 603 of rear axle mounting structure 503 is likewise disposed on a forward side of rear axle 501. As will be understood by one skilled in the art, numerous similar alternative designs are possible, and use of gauge 100 according to the method described hereinabove is contemplated with motorcycles according to such similar alternative designs.

According to an alternative embodiment of the present invention, the housing of the gauge may include a bend, a flexible portion, or other modification which allows the probe to be contacted with the reference surface of the rear axle adjustment device and the forward surface of the housing to be contacted with the reference surface of the rear axle mounting structure more easily, and preferably without interference between other parts of the gauge, such as the indicator or casing, and other parts of the motorcycle. Such a modification may also preferably allow the user to more easily read the value indicated, or handle and maneuver the gauge.

Having, thus, described exemplary embodiments of the present invention, it should be noted by those skilled in the art that the within disclosures are exemplary only and that various other alternatives, adaptations, and modifications may be made within the scope and spirit of the present invention. Accordingly, the present invention is not limited to the specific embodiments as illustrated herein, but is only limited by the following claims.

What is claimed is at least:

1. A motorcycle rear axle alignment gauge comprising:
a housing;
a probe movably engaged with said housing; and
an indicator operably engaged with said probe.

2. The motorcycle rear axle alignment gauge of claim 1, wherein said housing includes at least one portion adapted to abut a reference portion of the motorcycle.

3. The motorcycle rear axle alignment gauge of claim 1, wherein a scale is arranged around a peripheral portion of a face of said housing.

4. The motorcycle rear axle alignment gauge of claim 1, wherein said indicator comprises a needle, wherein said needle rotates about a first axis, orthogonal to a second axis of movement of said probe, and wherein said rotation is proportional to said movement.

5. The motorcycle rear axle alignment gauge of claim 3, wherein said face is rotatable relative to said housing such that a portion of said scale can be selectively positioned relative to said indicator for calibration.

6. The motorcycle rear axle alignment gauge of claim 2, wherein said at least one portion adapted to abut a reference portion of the motorcycle is selectively adjustable with respect to said probe for calibration.

7. The motorcycle rear axle alignment gauge of claim 1, wherein said indicator comprises an electronic display.

8. The motorcycle rear axle alignment gauge of claim 7, further comprising an electronic circuit operably connected to said probe and operably connected to said electronic display to provide a measurement signal to said electronic display for display thereon, said measurement signal being proportional to a distance between a portion of said housing adapted to abut a reference portion of the motorcycle.

9. The motorcycle rear axle alignment gauge of claim 8, wherein said electronic circuit comprises a calibration portion for setting said measurement signal value to a predetermined value.

10. A method of aligning a rear axle of a motorcycle comprising the steps of:
measuring a first position of a first rear axle adjustment device relative to a first portion of an axle-mounting structure of the motorcycle; and
adjusting said first rear axle adjustment device to align the rear axle of the motorcycle.

11. The method of aligning a rear axle of a motorcycle of claim 10, further comprising the step of:
measuring a first position of a second rear axle adjustment device relative to a second portion of the axle-mounting structure of the motorcycle.

12. The method of aligning a rear axle of a motorcycle of claim 11, further comprising the step of:
comparing said first position of said first rear axle adjustment device and said first position of said second rear axle adjustment device to align the rear axle.

13. The method of aligning a rear axle of a motorcycle of claim 10, further comprising the step of measuring a tension on at least one of a chain and a belt connected to the rear axle.

14. The method of aligning a rear axle of a motorcycle of claim 12, further comprising the step of adjusting at least one of said first rear axle adjustment screw and said second rear axle adjustment screw to adjust the tension on the chain or belt.

15. The method of aligning a rear axle of a motorcycle of claim 10, wherein said step of measuring said first position of said first rear axle adjustment device relative to said first portion of said axle-mounting structure comprises the steps of:
contacting a first portion of a probe with a first portion of said first rear axle adjustment device; and
contacting a first portion of a housing with a first portion of said rear axle-mounting structure of the motorcycle,
wherein said probe is operably connected to said housing.

16. The method of aligning a rear axle of a motorcycle of claim 10, further comprising the step of setting an indication of a distance between a first portion of a probe and a first portion of a housing of a gauge to a predetermined value, wherein said gauge is used to perform said step of measuring.

17. A method of measuring a position of a rear axle of a motorcycle relative to an axle-mounting structure of the motorcycle comprising the steps of:
contacting a first portion of a probe with a first portion of a rear axle adjustment device;
contacting a first portion of a housing with a first portion of the axle-mounting structure; and
measuring a distance between a the first portion of the probe and the first portion of the housing to measure the position of the rear axle relative to the axle-mounting structure.
